(19) United States
(12) Patent Application Publication
(10) Pub. No.: US 2026/0185551 A1
(43) Pub. Date: Jul. 2, 2026

(54) SOFA ASSEMBLING CONNECTING STRUCTURE

(71) Applicant: Xiang HE, Foshan (CN)

(72) Inventor: Xiang HE, Foshan (CN)

(21) Appl. No.: 19/082,575

(22) Filed: Mar. 18, 2025

(30) Foreign Application Priority Data
Dec. 29, 2024 (CN) 2024232572696

(51) Int. Cl. F16B 12/40; A47C 4/02

(52) U.S. Cl. CPC F16B 12/40; A47C 4/021

(57) ABSTRACT

The present invention discloses a sofa assembling connecting structure, which solves the technical problems that an existing latch cannot be interchanged up and down, is difficult to mount, and is difficult to assemble in place. The sofa assembling connecting structure includes a latch assembly and a positioning assembly. The latch assembly includes a male pin and female pin; the male pin includes a male pin main body and an L-shaped guide portion, so as to form a U-shaped groove, friction resistance when the male pin and the female pin are combined is reduced, friction abnormal sound is reduced, and the problems of large friction resistance of the traditional latch member and the friction abnormal sound of the hardware component are solved; the female pin includes a female pin main body and a plug; and the positioning assembly includes a positioning baffle and a mounting guide box.

### CROSS-REFERENCE TO RELATED APPLICATIONS

The application claims priority to Chinese patent application No. 2024232572696, filed on Dec. 29, 2024, the entire contents of which are incorporated herein by reference.

### TECHNICAL FIELD

The present invention relates to the technical field of sofa assembling devices, and in particular, to a sofa assembling connecting structure.

### BACKGROUND

The sofa assembling connecting structure is an important part in the field of furniture manufacturing, and the design thereof is directly related to the stability, durability and assembling convenience of furniture. In the prior art, a conical latch, as a common connecting structure, has been widely applied to an assembling process of a soft sofa.

The existing latch is generally conical, and has the characteristics of being narrow at the bottom and wide at the top, thick at the top and thin at the bottom. Such a design enables the goodness of fit between the male and female pins to gradually increase as the insertion depth increases in the insertion process of the latches, so that the components are connected more and more tightly. However, when an individual male and female latch of an existing latch is connected in place, the clearance is about 1 mm. For the soft furniture industry, the assembling process is mainly manual operation, the clearance of 1 mm results in an excessively high requirement for a manual requirement and mounting hole position of a product, a fault-tolerant gap is too small, and generally, two pairs of latches need to be mounted for connecting the two components of the sofa, the latches become tighter and tighter during the assembling process, and if there is a deviation, it is difficult to assemble the sofa in place, resulting in difficulty in mounting. Moreover, in order to prevent the latch from being over-inserted, the bottom portion of the female pin on the market is provided with a limiting structure, causing that the sofa mounting can only be in one direction and cannot be interchanged up and down, which limits the flexibility of furniture design.

### SUMMARY

In order to solve the technical problem, the present invention provides a sofa assembling connecting structure. To provide a basic understanding of some aspects of the disclosed embodiments, a simple summary is given below. This summary is neither a general comment nor intended to identify key/critical constituent elements or to depict the scope of protection of these embodiments. The sole purpose is to present some concepts in a simple form as a prelude to the detailed description that follows.

The present invention adopts the following technical solutions:
a sofa assembling connecting structure is provided, including a latch assembly and a positioning assembly, where
the latch assembly includes a male pin and a female pin;
the male pin includes a male pin main body and L-shaped guide portions symmetrically disposed on two sides of the male pin main body, the L-shaped guide portions and the male pin main body surround to form an inserting groove, and a width of the female pin is less than a distance between groove bottom walls of the two inserting grooves;
the female pin includes a female pin main body and plugs symmetrically disposed on two sides of the female pin main body, the plugs are embedded into the inserting groove, and a width of the plug is less than a groove width of the inserting groove; and
the positioning assembly comprises a positioning baffle and a mounting guide box bearing the positioning baffle, and when the positioning baffle is in a locking position of the mounting guide box, a front half section of the positioning baffle is located at a bottom portion of the male pin.

Further, an inclined opening is formed in both an upper end and a lower end of the plug and the L-shaped guide portion.

Further, a plurality of the mounting round holes are formed in the male pin main body and the female pin main body.

Further, a width of the male pin is 58 mm, a thickness of the male pin main body and the L-shaped guide portion is 2 mm, a distance between the groove bottom walls of the two inserting grooves is 54 mm, and the width of the female pin is 48 mm.

Further, the plug includes a first plate strip and a second plate strip; and a cross section of the female pin main body is U-shaped, the two sides of the female pin main body extend in a direction away from each other to form the first plate strip, and the first plate strip is bent towards a side where a fixed surface of the female pin is located to form the second plate strip.

Further, the groove width of the inserting groove is 9 mm, the width of the plug is 6.5 mm, and when the first plate strip is attached to the male pin main body, a distance between an outer side edge of the second plate strip and a groove wall of the inserting groove is 2.5 mm.

Further, through grooves are formed in box walls on two sides of the mounting guide box, two ends of the positioning baffle extend out from the through grooves, and an anti-disengaging block is disposed at a middle part of the positioning baffle; when the anti-disengaging block is attached to an inner wall of a front end box of the mounting guide box, the positioning baffle is in the locking position of the mounting guide box, and the front half section of the positioning baffle is located at the bottom portion of the male pin; and when the anti-disengaging block is attached to an inner wall of a rear end box of the mounting guide box, the positioning baffle is in an unlocking position of the mounting guide box, and the front half section of the positioning baffle is located inside the mounting guide box.

Further, the positioning assembly further includes an operating rod, and the operating rod is hinged to a rear half section of the positioning baffle.

Further, the positioning assembly further includes a mounting plate and a reinforcing rib plate, the mounting plate is disposed on both an upper side and a lower side of the mounting guide box, the reinforcing rib plate is disposed on the mounting plate, the reinforcing rib plate is connected to the mounting guide box, and a through hole is formed in the mounting plate.

The present invention has the following beneficial effects:
1. when the male pin and the female pin are mounted in a matched manner, sufficient assembling clearance is reserved in the structural design of the male pin and the female pin, and therefore, compared with the prior art, the present invention has a larger fault-tolerant adjustment limit and is more suitable for manual assembly of the soft sofa, assembling is not affected when the precision deviation is within the assembling clearance range, the upper and lower widths and the thicknesses of the latch assembly are the same, and the up-down direction do not need to be distinguished during connection, thus achieving a greater mounting flexibility; and
2. the latch assembly is used in cooperation with the positioning assembly, thereby reducing the mounting difficulty and ensuring the stability of the connection of the sofa component, facilitating the overall carrying and displacement of the sofa, and improving the mounting flexibility.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may derive other drawings from these accompanying drawings without creative efforts.

FIG. 1 is a schematic structural diagram of a latch assembly according to the present invention;

FIG. 2 is a schematic structural diagram after a male pin and a female pin are assembled according to the present invention;

FIG. 3 is a schematic cross-sectional view after a male pin and a female pin are assembled according to the present invention;

FIG. 4 is a front view of a male pin according to the present invention;

FIG. 5 is a side view of a male pin according to the present invention;

FIG. 6 is a top view of a male pin according to the present invention;

FIG. 7 is a perspective view of a male pin according to the present invention;

FIG. 8 is a front view of a female pin according to the present invention;

FIG. 9 is a side view of a female pin according to the present invention;

FIG. 10 is a top view of a female pin according to the present invention;

FIG. 11 is a perspective view of a female pin according to the present invention;

FIG. 12 is a schematic diagram of a position of a male pin and a positioning assembly when a positioning baffle is in a locking position of a mounting guide box according to the present invention;

FIG. 13 is a schematic diagram of a position of a male pin and a positioning assembly when a positioning baffle is in an unlocking position of a mounting guide box according to the present invention;

FIG. 14 is a schematic structural diagram when a male pin is mounted on a side surface of a seat package according to the present invention; and

FIG. 15 is a schematic structural diagram when a female pin is mounted on an inner side surface of an armrest according to the present invention.

### DETAILED DESCRIPTION OF THE EMBODIMENTS

The following describes the embodiments of the present invention in detail with reference to accompanying drawings. Apparently, the described embodiments are merely some but not all of the embodiments of the present invention. All other embodiments obtained by a person of ordinary skill in the art based on the embodiments of the present invention without creative efforts shall fall within the protection scope of the present invention.

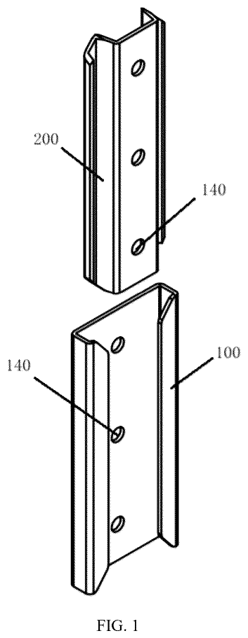

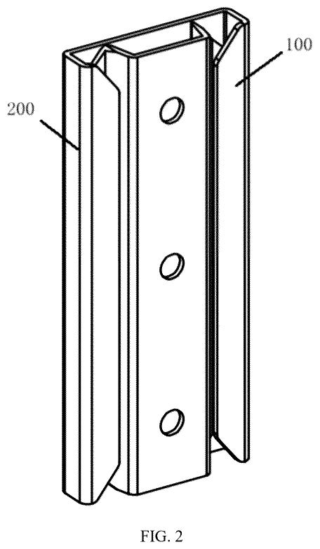

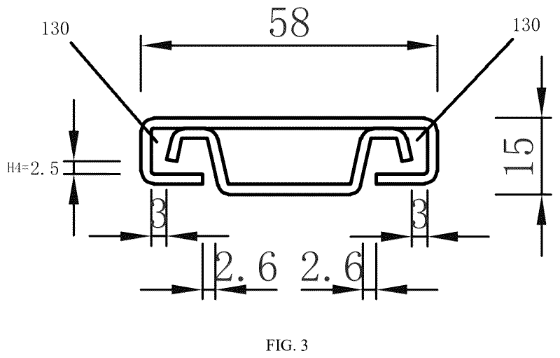

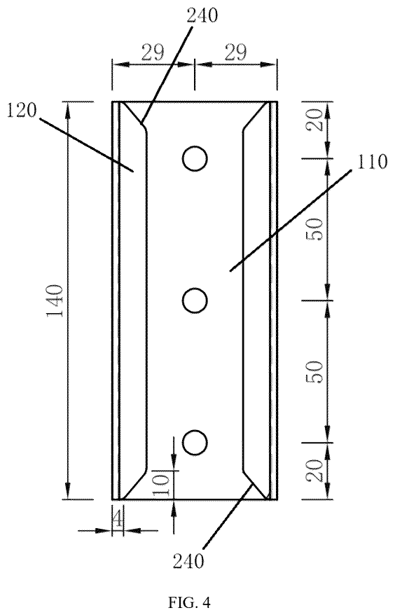

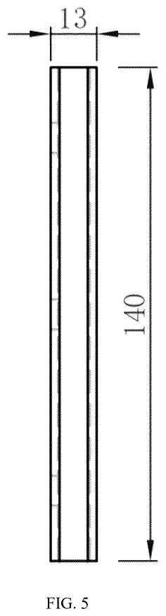

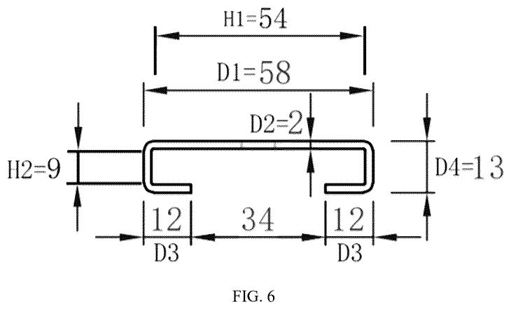

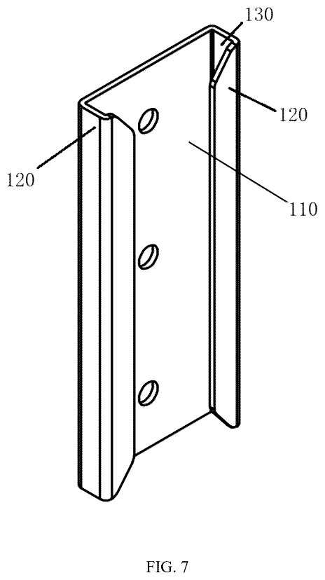

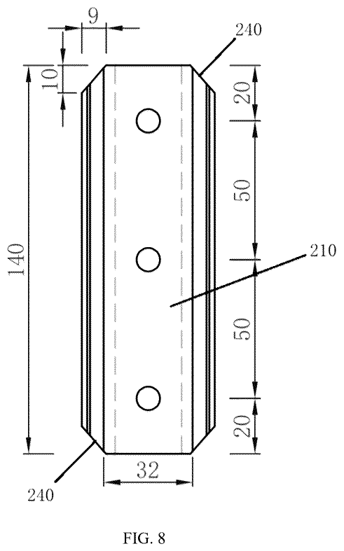

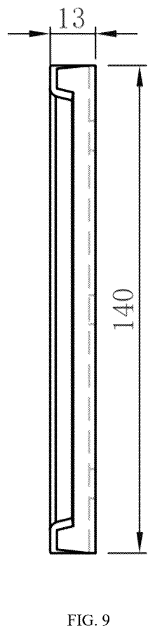

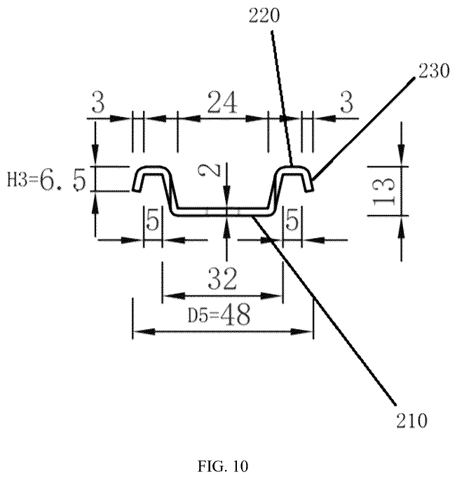

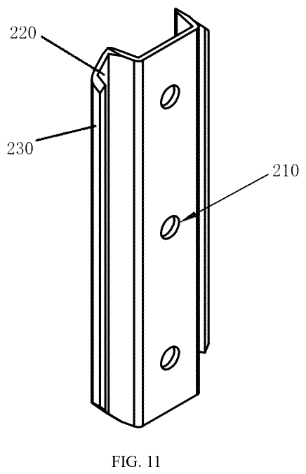

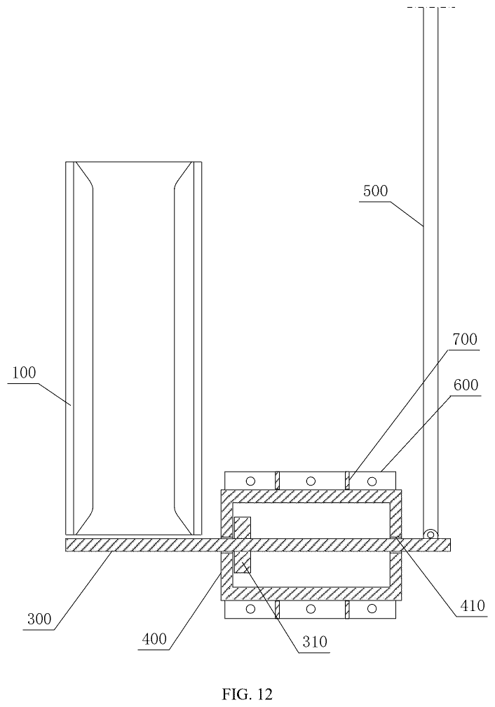

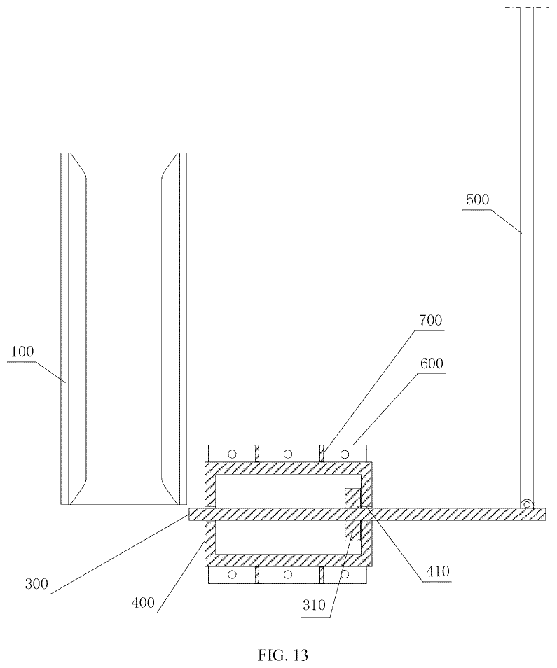

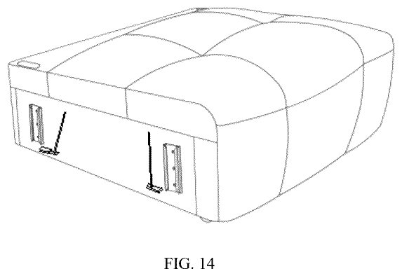

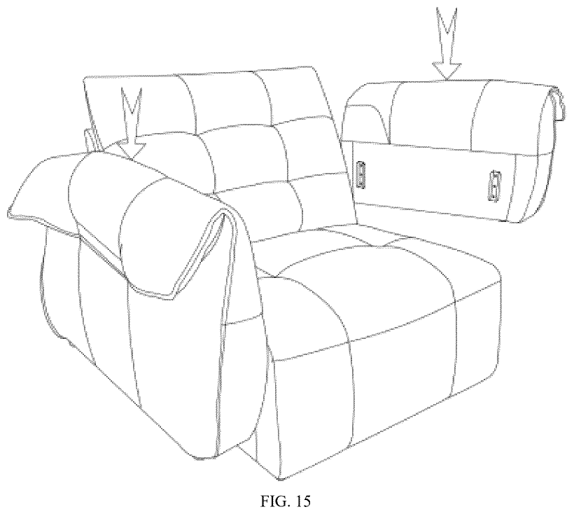

As shown in FIG. 1 to FIG. 15, in some illustrative embodiments, a sofa assembling connecting structure is provided, including a latch assembly and a positioning assembly.

The latch assembly includes a male pin 100 and a female pin 200. Generally, two male pins 100 or two female pins 200 are disposed on a side surface of a sofa seat package, two female pins 200 or two male pins 100 are disposed on an inner side surface of an armrest, and the positions of the male pins 100 and the female pins 200 correspond to each other and are interchangeable, so as to improve the flexibility of design. In this embodiment, the male pin 100 is used in cooperation with the female pin 200 to achieve assembling between the sofa seat package and the armrest.

The upper and lower widths of the male pin 100 are consistent, and the thickness of a plate member is consistent and is 2 mm. Specifically, the male pin includes a male pin main body 110 and L-shaped guide portions 120 symmetrically disposed on two sides of the male pin main body 110. The male pin main body 110 is of a flat plate-shaped structure, the L-shaped guide portion 120 is a plate body structure with an L-shaped cross section, and the L-shaped guide portion 120 and the male pin main body 110 are of an integrally formed structure. The L-shaped guide portions 120 and the male pin main body 110 surround to form an inserting groove 130, and there are two inserting grooves 130. The groove openings are opposite to each other and are configured to cooperate with the female pin 200 to achieve assembling. The L-shaped guide portion 120 is designed to serve as a guide to prevent the female pin 200 from being greatly deviated in the insertion process, and provide a limiting effect after the female pin 200 is inserted into the male pin 100, so as to prevent the female pin 200 from being laterally disengaged.

The upper and lower widths of the female pin 200 are consistent, and the thickness of a plate member is consistent and is 2 mm. Specifically, the female pin includes a female pin main body 210 and plugs symmetrically disposed on two sides of the female pin main body 210. The female pin main body 210 is of a plate member structure with a U-shaped cross section, and side edges of the female pin main body are obliquely disposed. The plug and the female pin main body 210 are of an integrally formed structure, and after the sofa is assembled, the plug is embedded into the inserting groove 130, thereby fixing a sofa component. The plug includes a first plate strip 220 and a second plate strip 230; and the two sides of the female pin main body 210 extend in a direction away from each other to form the first plate strip 220, the first plate strip 220 is bent towards a side where a fixed surface of the female pin 200 is located to form the second plate strip 230, and the second plate strip 230 is obliquely disposed, where the fixed surface of the female pin 200 refers to a surface attached to the sofa seat package or the armrest.

A plurality of the mounting round holes 140 are formed in the male pin main body 110 and the female pin main body 210. A diameter of the mounting round hole 140 is 8 mm, and the mounting round hole is configured to mount the male pin 100 and the female pin 200 on the sofa component through an M6*20 mm flat head screw.

An inclined opening 240 is formed in both an upper end and a lower end of the plug and the L-shaped guide portion 120. The inclined opening is a notch formed after an inclined plane is formed in the upper end and the lower end of the plug and an upper end and a lower end of the plate member parallel to the male pin main body 110 in the L-shaped guide portion 120. The inclined opening 240 is designed to facilitate the docking between the male pin 100 and the female pin 200, thereby reducing assembling difficulty.

The width D1 of the male pin 100 is 58 mm, the thickness D2 of the male pin main body 110 and the L-shaped guide portion 120 is 2 mm, and in the L-shaped guide portion 120, the width D3 of the plate member parallel to the male pin main body 110 is 12 mm, and the width D4 of the plate member perpendicular to the male pin main body 110 is 13 mm. Therefore, a distance H1 between the groove bottom walls of the two inserting grooves 130 is 58 mm−2 mm−2 mm=54 mm, and the groove width H2 of the inserting groove 130 is 13 mm−2 mm−2 mm=9 mm.

The width D5 of the female pin 200 is 48 mm. The width H3 of the plug is 6.5 mm, and when the first plate strip 220 is attached to the male pin main body 110, a distance H4 between an outer side edge of the second plate strip 230 and a groove wall of the inserting groove 130 is 9 mm−6.5 mm=2.5 mm.

Therefore, the width D5 of the female pin 200 is less than the distance H1 between the groove bottom walls of the two inserting grooves, and the reserved assembling clearance is 54 mm−48 mm=6 mm, and meanwhile, the width H3 of the plug is less than the groove width H2 of the inserting groove and the reserved assembling clearance is 9 mm−6.5 mm=2.5 mm.

When the male pin 100 and the female pin 200 are mounted in a matched manner, sufficient assembling clearance is reserved in the structural design of the male pin and the female pin, and therefore, compared with the prior art, the present invention has a larger fault-tolerant adjustment limit and is more suitable for manual assembly of the soft sofa. In addition, in the present application, the upper and lower widths and the thickness of the latch assembly are the same, a limiting structure is not disposed, the up-down direction does not need to be distinguished when the sofa is connected, and assembling is not affected when the precision deviation is within the assembling clearance range, thus achieving a greater mounting flexibility.

In order to ensure the stability of the overall connection of the sofa, in the present application, the positioning assembly is disposed on a side surface of the male pin 100, and specifically, the positioning assembly includes a positioning baffle 300, a mounting guide box 400, an operating rod 500, a mounting plate 600, and a reinforcing rib plate 700.

The mounting guide box 400 is configured to bearing the positioning baffle 300, through grooves 410 are formed in box walls on two sides of the mounting guide box 400, two ends of the positioning baffle 300 extend out from the through grooves 410, an anti-disengaging block 310 is disposed at a middle part of the positioning baffle 300, and a width of the anti-disengaging block 310 is greater than a groove width of the through groove 410. The anti-disengaging block 310 is designed to prevent the positioning baffle 300 from being disengaged from the mounting guide box 400, and limit a limiting position that can be reached when the positioning baffle 300 moves left and right, so as to determine a locking position and an unlocking position.

When the anti-disengaging block 310 is attached to an inner wall of a front end box of the mounting guide box 400, the positioning baffle 300 is in the locking position of the mounting guide box 400, and at the moment, a front half section of the positioning baffle 300 completely extends out from the through groove 410 in the box wall at the front end, and the front half section of the positioning baffle 300 is located at a bottom portion of the male pin 100 to close the bottom portion of the male pin 100, so that the female pin 200 cannot be disengaged from the bottom portion of the male pin 100, and the connection is more stable, thereby facilitating the overall carrying and displacement of the sofa.

When the sofa is lifted, due to the weight of the armrest, the female pin 200 applies certain pressure to the positioning baffle 300, so that there is a sufficient friction force between an upper surface of the positioning baffle 300 and a lower end surface of the female pin 200, and the positioning baffle 300 is not prone to retracting to an original position. Therefore, it is unnecessary to design a fixed structure to keep the positioning baffle 300 in the locking position.

When the anti-disengaging block 310 is attached to an inner wall of a rear end box of the mounting guide box 400, the positioning baffle 300 is in the unlocking position of the mounting guide box 400, the front half section of the positioning baffle 300 is located inside the mounting guide box 400, and at the moment, the positioning baffle 300 no longer limits downward movement of the female pin 200, and therefore, the sofa component can be freely disassembled and assembled. In this embodiment, the front end of the mounting guide box 400 and the front half section of the positioning baffle 300 refer to one side closer to the male pin 100.

When the latch assembly is used in cooperation with the positioning assembly, and the positioning assembly does not perform limitation, the latch assembly does not need to distinguish the up-down direction when the sofa is connected, and after assembling is completed, the positioning assembly performs limitation, so as to ensure the stability of the overall connection of the sofa, and facilitate the overall carrying and displacement of the sofa. Therefore, the structural design of the present application can ensure the stability of the connection of the sofa component while reducing the mounting difficulty, thereby improving the mounting flexibility.

The operating rod 500 is hinged to the rear half section of the positioning baffle 300, and after the sofa is assembled, the operating rod 500 is clamped between the sofa seat package and the armrest. Since the sofa component is soft, a sufficient deformable space can be provided for using the operating rod 500, and the positioning baffle 300 is pulled through the operating rod 500 to move left and right, which has the advantage of being easy to operate.

The mounting plate 600 is disposed on both an upper side and a lower side of the mounting guide box 400, a through hole is formed in the mounting plate 600. The mounting plate 600 is fixed to the sofa component through a bolt, so that the mounting guide box 400 is fixed to the sofa. The reinforcing rib plate 700 is disposed on the mounting plate 600, and the reinforcing rib plate 700 is connected to the mounting guide box 400. The reinforcing rib plate 700 is designed to increase the strength of the mounting guide box 400, so that the positioning baffle 300 can provide a sufficient support force to bear the female pin 200.

The above is only the specific embodiments of the present invention, but the scope of protection of the present invention is not limited thereto. Any changes or replacements that can be easily thought by those skilled in the art within the scope of disclosure of the present invention shall fall within the scope of protection of the present invention. Therefore, the scope of protection of the present invention shall be subject to the scope of protection of the appended claims.

What is claimed is:

1. A sofa assembling connecting structure, comprising a latch assembly and a positioning assembly, wherein
the latch assembly comprises a male pin and a female pin;
the male pin comprises a male pin main body and L-shaped guide portions symmetrically disposed on two sides of the male pin main body, the L-shaped guide portions and the male pin main body surround to form an inserting groove, and a width of the female pin is less than a distance between groove bottom walls of the two inserting grooves;
the female pin comprises a female pin main body and plugs symmetrically disposed on two sides of the female pin main body, the plugs are embedded into the inserting groove, and a width of the plug is less than a groove width of the inserting groove; and
the positioning assembly comprises a positioning baffle and a mounting guide box bearing the positioning baffle, and when the positioning baffle is in a locking position of the mounting guide box, a front half section of the positioning baffle is located at a bottom portion of the male pin.

2. The sofa assembling connecting structure according to claim 1, wherein an inclined opening is formed in both an upper end and a lower end of the plug and the L-shaped guide portion.

3. The sofa assembling connecting structure according to claim 2, wherein a plurality of the mounting round holes are formed in the male pin main body and the female pin main body.

4. The sofa assembling connecting structure according to claim 3, wherein a width of the male pin is 58 mm, a thickness of the male pin main body and the L-shaped guide portion is 2 mm, a distance between the groove bottom walls of the two inserting grooves is 54 mm, and the width of the female pin is 48 mm.

5. The sofa assembling connecting structure according to claim 4, wherein the plug comprises a first plate strip and a second plate strip; and a cross section of the female pin main body is U-shaped, the two sides of the female pin main body extend in a direction away from each other to form the first plate strip, and the first plate strip is bent towards a side where a fixed surface of the female pin is located to form the second plate strip.

6. The sofa assembling connecting structure according to claim 5, wherein the groove width of the inserting groove is 9 mm, the width of the plug is 6.5 mm, and when the first plate strip is attached to the male pin main body, a distance between an outer side edge of the second plate strip and a groove wall of the inserting groove is 2.5 mm.

7. The sofa assembling connecting structure according to claim 6, wherein through grooves are formed in box walls on two sides of the mounting guide box, two ends of the positioning baffle extend out from the through grooves, and an anti-disengaging block is disposed at a middle part of the positioning baffle; when the anti-disengaging block is attached to an inner wall of a front end box of the mounting guide box, the positioning baffle is in the locking position of the mounting guide box, and the front half section of the positioning baffle is located at the bottom portion of the male pin; and when the anti-disengaging block is attached to an inner wall of a rear end box of the mounting guide box, the positioning baffle is in an unlocking position of the mounting guide box, and the front half section of the positioning baffle is located inside the mounting guide box.

8. The sofa assembling connecting structure according to claim 7, wherein the positioning assembly further comprises an operating rod, and the operating rod is hinged to a rear half section of the positioning baffle.

9. The sofa assembling connecting structure according to claim 8, wherein the positioning assembly further comprises a mounting plate and a reinforcing rib plate, the mounting plate is disposed on both an upper side and a lower side of the mounting guide box, the reinforcing rib plate is disposed on the mounting plate, the reinforcing rib plate is connected to the mounting guide box, and a through hole is formed in the mounting plate.
